(19) United States
(12) Patent Application Publication
(10) Pub. No.: US 2025/0065223 A1
(43) Pub. Date: Feb. 27, 2025

(54) BUTTON CAP OF GAMEPAD

(71) Applicant: YUANMU ZHU, SHANWEI CITY (CN)

(72) Inventor: YUANMU ZHU, SHANWEI CITY (CN)

(21) Appl. No.: 18/475,259

(22) Filed: Sep. 27, 2023

(30) Foreign Application Priority Data
Aug. 22, 2023 (CN) 202322267717.X

(51) Int. Cl. A63F 13/24

(52) U.S. Cl. CPC A63F 13/24

(57) ABSTRACT

The present disclosure relates to the entertainment device field, including a base and an installation cover buckled on the base. The base is configured for being installed on a joystick button of the gamepad, and an adjustment mechanism is formed at a connection between the base and the installation cover and configured to adjust a connection height. The adjustment mechanism is a gear structure provided with tooth heights having different heights, so that the installation cover and the base are engaged to each other and rotated to adjust a height of the button cap, or the adjustment mechanism is a buckle structure in which a plurality of slots having different accommodating depths are provided on the base, so that the height of the button cap is configured to be adjusted by the installation cover through inserting at least one hook correspondingly into the plurality of slots.

### FIELD OF THE DISCLOSURE

The present disclosure relates to the technical field of entertainment devices, and more particularly to a button cap of a gamepad.

### BACKGROUND OF THE DISCLOSURE

The gamepad is a common part of an electronic game machine. By manipulating its buttons, the user can control the game character. The gamepad is often provided with joystick buttons, and the user can control the movement of the game character by toggling the joystick buttons. The height of the joystick buttons has a certain impact on the user's gaming experience. Generally speaking, a lower height of the joystick buttons can provide more feedback control, which is more suitable for games that require precise control, such as shooting games, making it easier for players to achieve high-precision control. The joystick buttons having a higher height can make user's fingers move more smoothly and reduce the error caused by the fingers moving too fast, and are suitable for games that require fast movement, such as racing games.

The existing joystick buttons are usually provided with a button cap on the joystick button to increase the overall height, which is convenient for the user to quickly toggle the movement control of the game character, but the existing button caps often cannot be adjusted in height. Therefore, it is inconvenient for users to choose a suitable height according to preferences and game types, and the versatility is low.

### SUMMARY OF THE DISCLOSURE

The problem solved by the present disclosure is how to provide a button cap of a gamepad, which can adjust a height of the button cap and improve a versatility of the button cap.

In order to solve the above-mentioned problems, the present disclosure provides a button cap of a gamepad, which includes: a base and an installation cover buckled on the base. The base is configured for being installed on a joystick button of the gamepad, an adjustment mechanism is formed at a connection between and the base and the installation cover and configured to adjust a connection height. The adjustment mechanism is a gear structure provided with tooth heights having different heights, so that the installation cover and the base are engaged with each other and rotated to adjust a height of the button cap by the gear structure, or the adjustment mechanism is a buckle structure in which a plurality of slots having different accommodating depths are provided on the base, so that the height of the button cap is configured to be adjusted by the installation cover through inserting at least one hook correspondingly into the plurality of slots.

Preferably, the buckle structure has a connecting post arranged on the base, and multiple hooks arranged at intervals around the connecting post. A side of the installation cover facing the base is provided with an accommodating slot, a circumferential inner wall of the accommodating slot is provided with the plurality of slots at intervals, the plurality of slots are sequentially divided into a plurality of slot groups, and accommodation depths of the plurality of slot groups are arranged to increase or decrease, so that each of the multiple hooks is inserted to a corresponding one of the plurality of slots having different accommodating depths to adjust the height of the button cap.

Preferably, each of the multiple hooks has a hook body, a gap is formed between the hook body and the connecting post, the hook body is an elastic member capable of rebounding and resetting after moving adjacent to the connecting post, a protruding portion is provided on an end of a side of the hook body away from the connecting post, and a protruding block is correspondingly provided on an inner wall of the slot, so that when the hook is inserted into the slot, the protruding portion rebounds and is engaged above the protruding block.

Preferably, a bottom of the slot is a penetrable structure. In each of the plurality of slot groups, a height of a side wall of each of the slots adjacent to a center of the accommodating slot is arranged to increase or decrease to form an abutment wall, and the abutment wall is engaged in the gap formed between the hook body and the connecting post, so that different accommodating depths are correspondingly formed in the slots.

Preferably, a plurality of strip-shaped grooves are arranged at intervals on a circumferential outer wall of the installation cover, the plurality of strip-shaped grooves are respectively arranged to the plurality of slots, and a length of each of the plurality of strip-shaped grooves indicates a height level of the button cap after each of the multiple hooks is inserted into the corresponding one of the plurality of slots, so as to facilitate user's identification and selection.

Preferably, a top cover installed on the installation cover is further comprises a side of the top cover facing the installation cover which is provided with an inner accommodating slot configured to be buckled on the installation cover, a middle part of the installation cover is provided with an opening, and the side of the top cover facing the installation cover is provided with a protruding post configured to be inserted into the opening.

Preferably, a pattern is provided on a surface of the top cover away from the installation cover to increase a friction between the top cover and user's fingers.

Preferably, the gear structure has a connecting post arranged on the base and a plurality of tooth posts arranged at intervals around the connecting post. A side of the installation cover facing the base is provided with an accommodating slot, a plurality of tooth slots are arranged around a circumferential inner wall of the accommodating slot, the plurality of tooth slots are sequentially divided into a plurality of tooth slot groups, and tooth heights of the plurality of tooth slot groups are arranged to increase or decrease, so that the plurality of tooth posts are rotated to adjust the height of the button cap after the plurality of tooth posts and the plurality of tooth slots are correspondingly engaged to each other.

Preferably, an outer edge extending outwards from an outer circumference of an end of the installation cover away from the accommodating slot is provided to facilitate a user to toggle the installation cover.

Preferably, a plurality of clamping arms extending downwards are arranged at intervals on a circumference of a side of the base away from the installation cover, and each of the plurality of clamping arms is bent inwardly and elastic, so as to be detachably buckled on the joystick button of the gamepad.

Compared with the beneficial effects of the prior art, the button cap in the present disclosure includes the base and the installation cover interlocked with each other, and the adjustment structure is formed between the base and the installation cover. Optionally, the adjustment mechanism is the gear structure, the installation cover and the base are engaged to each other and rotated through the tooth slots, and the tooth slots are provided with different tooth heights, so that the user can adjust the height of the button cap when rotating the installation cover, so as to adjust a height of the joystick button. Optionally, the adjustment mechanism can be the buckle structure. The slots having different accommodating depths are arranged on the base, and the hooks are correspondingly provided on the installation cover, so that the user can selectively insert the hooks of the installation cover correspondingly into the slots having different accommodation depths to adjust the height of the button cap, and also adjust the height of the joystick button. To sum up, the above two methods can facilitate the user to select and adjust the height of the joystick button according to preferences and game types, and also improve the versatility of the button cap.

### BRIEF DESCRIPTION OF THE DRAWINGS

FIG. 1 is an exploded view of a button cap of a gamepad according to an embodiment of the present disclosure;

FIG. 2 is another exploded view of the button cap of a gamepad according to the embodiment of the present disclosure;

FIG. 3 is yet another exploded view of the button cap of a gamepad according to the embodiment of the present disclosure;

FIG. 4 is a schematic structural diagram of an installation cover according to the embodiment of the present disclosure;

FIG. 5 is still another exploded view of the button cap of a gamepad according to the embodiment of the present disclosure; and

FIG. 6 is another schematic structural diagram of the installation cover according to an embodiment of the present disclosure.

Reference numeral: 1, base; 2, installation cover; 3, top cover; 11, connecting post; 12, hook; 120, hook body; 121, protruding portion; 13, clamping arm; 14, tooth post; 21, accommodating slot; 210, slot; 211, abutment wall; 22, strip-shaped groove; 23, outer edge; 24, tooth slot; 31, inner accommodating slot; 32, protruding post.

### DETAILED DESCRIPTION OF THE EXEMPLARY EMBODIMENTS

In order to make the above purpose, features and advantages of the present disclosure more obvious and easy to understand, specific embodiments of the present disclosure will be described in detail below in conjunction with the accompanying drawings.

It should be noted that the terms “first” and “second” in the specification and claims of the present disclosure and the above drawings are used to distinguish similar objects, but not necessarily used to describe a specific order or sequence. It is to be understood that the data so used are interchangeable under appropriate circumstances such that the embodiments of the present disclosure described herein can be practiced in sequences other than those illustrated or described herein.

In the description of the present disclosure, it should be noted that, unless otherwise specified and limited, the terms “arrangement”, “installation”, “connecting” and “connection” should be understood in a broad sense, for example, it may be a fixed connection, detachably connected or integrally connected. It can be mechanically connected, directly connected or indirectly connected through an intermediary, and can be internal communication between two components. Those of ordinary skill in the art can understand the specific meanings of the above terms in the present disclosure in specific situations.

In the description of this specification, descriptions with reference to the terms “an embodiment”, “one embodiment” and “an implementation” mean that the specific features, structures, materials or characteristics described in conjunction with the embodiment or implementation are comprised in at least one embodiment or embodiments of this specification of the present disclosure. In this specification, the schematic representations of the above terms do not necessarily refer to the same embodiment or implementation. Furthermore, the specific features, structures, materials or characteristics described may be combined in any suitable manner in any one or more embodiments or implementations.

The present disclosure is described in detail in conjunction with the accompanying drawings.

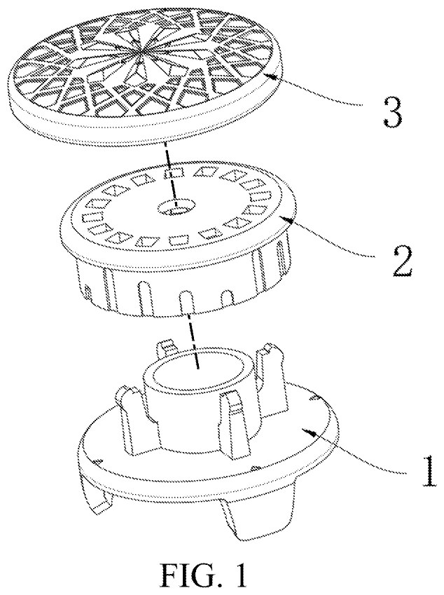

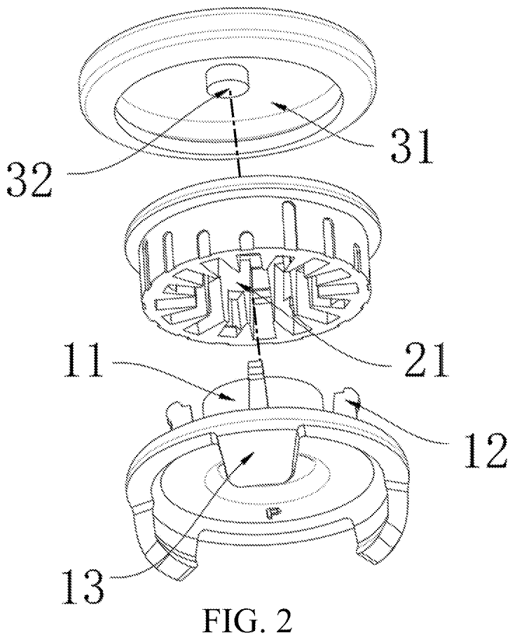

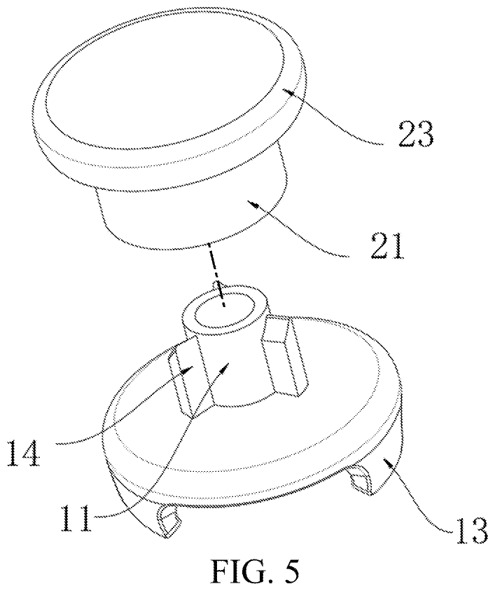

In order to solve the above-mentioned technical problems, as shown in FIG. 1, FIG. 2 and FIG. 5, the embodiment of the present disclosure provides a button cap of a gamepad, which includes a base 1 and an installation cover 2 buckled on the base 1. The base 1 is configured for being installed on a joystick button of the gamepad, and an adjustment mechanism is formed at a connection between the base 1 and the installation cover 2 and configured to adjust a connection height. The adjustment mechanism is a gear structure provided with tooth heights having different heights so that the installation cover 2 and the base 1 are engaged to each other and rotated to adjust a height of the button cap. Alternatively, the adjustment mechanism is a buckle structure in which a plurality of slots 210 having different accommodating depths are provided on the base 1, so that the height of the button cap is configured to be adjusted by the installation cover 2 through inserting at least one hook 12 into the plurality of slots 210.

It should be noted that the button cap includes the base 1 and the installation cover 2 interlocked with each other, and the adjustment structure is formed between the base 1 and the installation cover 2. Optionally, the adjustment mechanism is the gear structure. The installation cover 2 and the base 1 are engaged to each other and rotated through tooth slots 24, and the tooth slots 24 are provided with different tooth heights, so that a user can adjust the height of the button cap when rotating the installation cover 2, so as to adjust a height of the joystick button. Optionally, the adjustment mechanism can be the buckle structure. The slots 210 having different accommodating depths are provided on the base 1, and the hooks 12 are correspondingly provided on the installation cover 2, so that the user can selectively insert the hooks 12 of the installation cover 2 correspondingly into the slots 210 having different accommodating depths to adjust a height of the button cap and also adjust a height of the joystick button. In summary, the above two methods can facilitate the user to select and adjust a height of the joystick button according to preferences and game types, and also improve the versatility of the button cap.

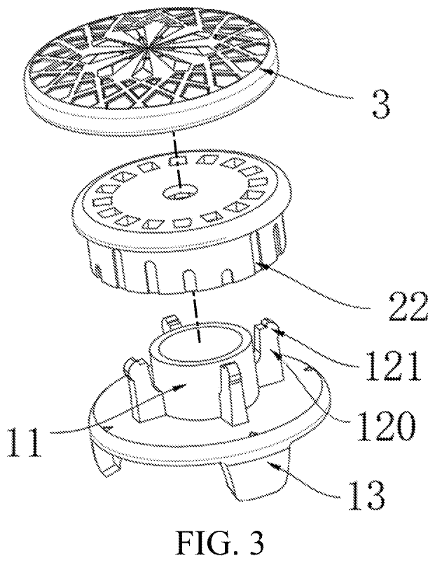

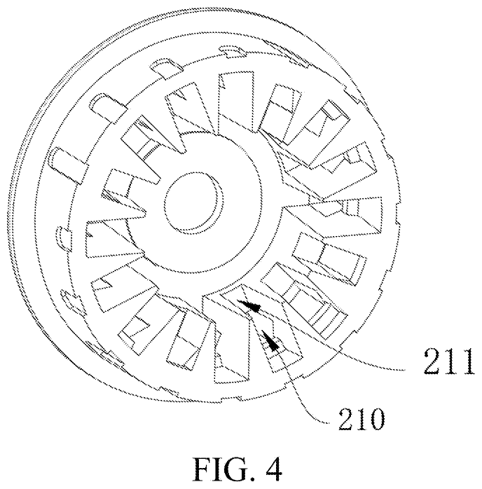

In one embodiment of the present disclosure, in which is to be read in conjunction with FIG. 1, FIG. 2, FIG. 3 and FIG. 4, the buckle structure has a connecting post 11 arranged on the base 1, and multiple hooks 12 arranged at intervals around the connecting post 11. A side of the installation cover 2 facing the base 1 is provided with an accommodating slot 21, a circumferential inner wall of the accommodating slot 21 is provided with the plurality of slots 210 at intervals, the plurality of slots 210 are sequentially divided into a plurality of slot groups, and accommodation depths of the plurality of slot groups are arranged to increase or decrease, so that each of the multiple hooks 12 are correspondingly inserted to the plurality of slots 210 having different accommodating depths to adjust the height of the button cap.

It should be noted that the buckle structure has the connecting post 11 arranged on the base 1. Preferably, the connecting post 11 is arranged in a middle part of the base 1, and is a cylindrical structure of which two ends each are openings. The connecting post 11 is abutted against the installation cover 2, and a protrusion is provided on a position where the installation cover 2 and the connecting post 11 are connected to each other, so that the connecting post 11 is nested and abutted against the protrusion. The connecting post 11 can play a role of connection and support, the multiple hooks 12 are arranged around the circumferential side of the connecting post 11, and the side of the installation cover 2 facing the base 1 is provided with the accommodating slot 21. The plurality of slots 210 are arranged at intervals on the circumferential inner wall of the accommodating slot 21, the plurality of slots 210 are sequentially divided into the plurality of slot groups according to a number of the multiple hooks 12. For example, when the number of the hooks 12 is four, the plurality of slots 210 are sequentially divided into four slot groups, and accommodating depths of the four slot groups are arranged to increase or decrease, so that the multiple hooks 12 can correspond to the plurality of slot groups having a same accommodating depth, causing a stable insertion. In addition, since the multiple hooks 12 are correspondingly inserted into the plurality of slots 210 having different accommodating depths, the height of the button cap can also be adjusted.

In one embodiment of the present disclosure, in which is to be read in conjunction with FIG. 3, each of the multiple hooks 12 has a hook body 120, a gap is formed between the hook body 120 and the connecting post 11, and the hook body 120 is an elastic member capable of rebounding and resetting after moving adjacent to the connecting post 11. The end of the side of the hook body 120 away from the connecting post 11 is provided with a protruding portion 121, and the inner wall of the slot 210 is correspondingly provided with a protruding block, so that when the hook 12 is inserted into the slot 210, the protruding portion 121 rebounds and is engaged above the protruding block.

It should be noted that the gap is formed between the hook body 120 and the connecting post 11, and the hook body 120 is the elastic member capable of rebounding and resetting after moving adjacent to the connecting post 11. The end of the side of the hook body 120 away from the connecting post 11 is provided with the protruding portion 121, and the inner wall of the slot 210 is correspondingly provided with the protruding block, so that in the process of inserting the hook body 120 into the slot 210, since the protruding portion 121 is pressed by the protruding block, the hook body 120 will elastically move toward the direction adjacent to the connecting post 11, and the protruding portion 121 can pass through the protruding block. After passing through the protruding block, the hook body 120 is elastically reset, so that the protruding portion 121 is engaged above the protruding block, and the hook 12 is elastically locked to avoid falling off when the use is using.

In one embodiment of the present disclosure, which is to be read in conjunction with FIG. 4, a bottom of the slot 210 is a penetrable structure. In each of the plurality of slot groups, the height of each of side walls of the slots 210 adjacent to a center of the accommodating slot 21 is arranged to increase or decrease to form an abutment wall 211, and the abutment wall 211 is engaged between the hook body 120 and the connecting post 11, so that different accommodating depths are correspondingly formed in the slots 210.

It should be noted that the bottom of the slot 210 is the penetrable structure, that is, the bottom of the slot 210 is provided with an opening, so that an end of the hook 12 penetrates and fastens the hook 12 through the opening. In each of the plurality of slot groups, the heights of the side walls of the slot 210 adjacent to the center of the accommodating slot 21 are arranged to increase or decrease to form an abutment wall 211. When the hook 12 is inserted into the slot 210, the abutment wall 211 will be locked in the gap between the hook body 120 and the connecting post 11, so that the accommodation depth of the slot 210 can be adjusted conveniently. Optionally, the height of a lowest abutment wall 211 is 0.

In one embodiment of the present disclosure, which is to be read in conjunction with FIG. 3, a plurality of strip-shaped grooves 22 are arranged at intervals on a circumferential outer wall of the installation cover 2, and the plurality of strip-shaped grooves 22 are respectively arranged to the plurality of slots 210, and a length of each of the plurality of strip-shaped grooves 22 indicates a height level of the button cap after the hook 12 is inserted into a corresponding one of the slots 210, so as to facilitate user's identification and selection.

It should be noted that the plurality of strip-shaped grooves 22 that are vertical are arranged at intervals on the circumferential outer wall of the installation cover 2, each of the plurality of strip-shaped grooves 22 is correspondingly arranged to the plurality of slots 210, and the length of each of the plurality of strip-shaped grooves 22 is arranged to a corresponding length due to the difference in height after the installation cover 2 is inserted into the corresponding one of the slots 210, so that it is convenient for the user to selectively insert the installation cover 2 into a corresponding one of the slots 210 from the outer circumference of the installation cover 2, so as to facilitate the convenient usage for the user.

In one embodiment of the present disclosure, which is to be read in conjunction with FIG. 2, a top cover 3 installed on the installation cover 2 is further provided. One side of the top cover 3 facing the installation cover 2 is provided with an inner accommodating slot 31 configured to be buckled on the installation cover 2. An opening is provided in a middle part of the installation cover 2, and a protruding post 32 is provided on the one side of the top cover 3 facing the installation cover 2, for being inserted into the opening.

It should be noted that the top cover 3 is further provided on the installation cover 2, the one side of the top cover 3 facing the installation cover 2 is provided with the inner accommodating slot 31, and the inner accommodating slot 31 can be buckled on the top of the installation cover 2, so that the top cover 3 can be detachably buckled on the installation cover 2. The middle part of the installation cover 2 is provided with an opening, and preferably, the opening is a circle-shaped hole. A middle part of the side of the top cover 3 facing the installation cover 2 is correspondingly provided with the protruding post 32, and preferably, the protruding post 32 is a cylinder, so that the protruding post 32 can be inserted into the opening to further connect the top cover 3 and the installation cover 2 to avoid falling off. The top cover 3 can further result in a height increase of the joystick button, which is convenient for the user to toggle, and the top cover 3 covered on the installation cover 2 can be more aesthetically pleasing.

In one embodiment of the present disclosure, which is to be read in conjunction with FIG. 1, a pattern is provided on a surface of the top cover 3 away from the installation cover 2 to increase a friction between the top cover 3 and the user's fingers.

It should be noted that, as shown in the figure, the top cover 3 is provided with the pattern on the surface away from the installation cover 2, and the pattern can be selected and arranged according to a model of the product or a preference of the user. In addition, the pattern can increase the friction between the top cover 3 and the user's fingers, which is convenient for the user to move, and another convenience is to increase the overall aesthetics and delicacy.

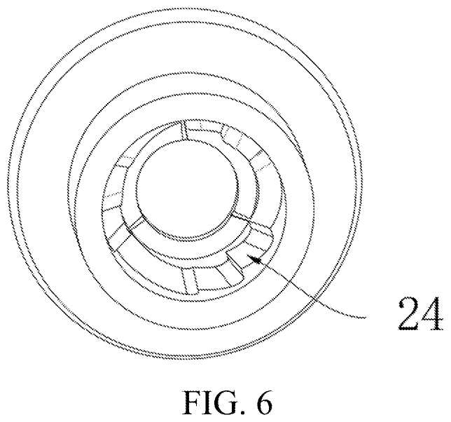

In one embodiment of the present disclosure, which is to be read in conjunction with FIG. 5 and FIG. 6, the gear structure has a connecting post 11 arranged on the base 1, and a plurality of tooth posts 14 arranged at intervals around the connecting post 11. The side of the installation cover 2 facing the base 1 is provided with the accommodating slot 21, a plurality of tooth slots 24 are arranged around the circumferential inner wall of the accommodating slot 21, the plurality of tooth slots 24 are sequentially divided into a plurality of tooth slot groups, and tooth heights of the plurality of tooth slot groups are arranged to increase or decrease, so that the plurality of tooth posts 14 are rotated to adjust the height of the button cap after the plurality of tooth posts 14 and the plurality of tooth slots 24 are correspondingly engaged to each other.

It should be noted that the gear structure has the connecting post 11 arranged on the base 1, and the connecting post 11 is the same as above, that is, preferably, the connecting post 11 is arranged in the middle part of the base 1 and is a cylindrical structure of which two ends each are the openings. The connecting post 11 is abutted against the installation cover 2, and the protrusion is provided on the position where the installation cover 2 and the connecting post 11 are connected to each other, so that the connecting post 11 is nested and abutted against the protrusion. The connecting post 11 can play the role of connection and support. The plurality of tooth posts 14 are arranged at intervals around the circumferential side of the connecting post 11, a top of each of the plurality of tooth posts 14 is arranged to be chamfered, the plurality of tooth slots 24 are arranged around the circumferential inner wall of the accommodating slot 21, and each of the plurality of tooth posts 14 with a chamfered top and the plurality of tooth slots 24 are engaged to each other and rotated. The plurality of tooth slots 24 are sequentially divided into the plurality of tooth slot groups according to a number of the tooth posts 12. For example, when the number of the tooth posts 14 is three, the plurality of tooth slots 14 are sequentially divided into three tooth slot groups, and tooth heights of the three tooth slot groups are arranged to increase or decrease, so that each of the plurality of tooth slots 24 can be rotated synchronously to adjust the height of the button cap after the plurality of tooth slots 24 and the plurality of tooth slots 24 having a same tooth height are correspondingly engaged to each other. This adjustment method only needs a rotation, which is convenient and fast.

In one embodiment of the present disclosure, which is to be read in conjunction with FIG. 5, an outer edge 23 extending outwards from an outer circumference of an end of the installation cover 2 away from the accommodating slot 21 is provided to facilitate a user to toggle the installation cover 2.

It should be noted that, the outer circumference of the end of the installation cover 2 away from the accommodating slot 21 is extended outwardly with the outer edge 23 to form an outwardly expanded cap shape, so that it is convenient for the user to manipulate the joystick button by toggling the installation cover 2, so as to improve the use sensation for the user.

In one embodiment of the present disclosure, which is to be read in conjunction with FIG. 2 and FIG. 5, a plurality of clamping arms 13 extending downwards are arranged at intervals on a circumference of a side of the base 1 away from the installation cover 2, and each of the plurality of clamping arms 13 is bent inwardly and elastic, so as to be detachably buckled on the joystick button of the gamepad.

It should be noted that the plurality of clamping arms 13 extending downwards are arranged at intervals on the circumference of the side of the base 1 away from the installation cover 2. Preferably, a number of the clamping arms 13 is three and each of the three clamping arms 13 is arranged in a certain curved arc inwardly and has elasticity, so as to be buckled on the joystick button by pressing while being convenient for disassembly and replacement.

It should be noted that the above-mentioned technical features can be combined with each other to form various embodiments not listed above, which are all considered as the scope of the description of the present disclosure. Moreover, those skilled in the art can make improvements or transformations according to the above description, and all these improvements and transformations should belong to the protection scope of the appended claims of the present disclosure.

What is claimed is:

1. A button cap of a gamepad, comprising:
a base (1) and an installation cover (2) buckled on the base (1), wherein the base (1) is configured for being installed on a joystick button of the gamepad, an adjustment mechanism is formed at a connection between the base (1) and the installation cover (2) and configured to adjust a connection height, and the adjustment mechanism is a gear structure provided with tooth heights having different heights, so that the installation cover (2) and the base (1) are engaged to each other and rotated to adjust a height of the button cap by the gear structure, or the adjustment mechanism is a buckle structure in which a plurality of slots (210) having different accommodating depths are provided on the base (1), so that the height of the button cap is configured to be adjusted by the installation cover (2) through inserting at least one hook (12) correspondingly into the plurality of slots (210).

2. The button cap of a gamepad according to claim 1, wherein the buckle structure has a connecting post (11) arranged on the base (1), and multiple hooks (12) arranged at intervals around the connecting post (11); a side of the installation cover (2) facing the base (1) is provided with an accommodating slot (21), a circumferential inner wall of the accommodating slot (21) is provided with the plurality of slots (210) at intervals, the plurality of slots (210) are sequentially divided into a plurality of slot groups, and accommodation depths of the plurality of slot groups are arranged to increase or decrease, so that each of the multiple hooks (12) is inserted to a corresponding one of the plurality of slots (210) having different accommodating depths to adjust the height of the button cap.

3. The button cap of a gamepad according to claim 2, wherein each of the multiple hooks (12) has a hook body (120), a gap is formed between the hook body (120) and the connecting post (11), the hook body (120) is an elastic member capable of rebounding and resetting after moving adjacent to the connecting post (11), a protruding portion (121) is provided on an end of a side of the hook body (120) away from the connecting post (11), and a protruding block is correspondingly provided on an inner wall of the slot (210), so that when the hook (12) is inserted into the slot (210), the protruding portion (121) rebounds and is engaged above the protruding block.

4. The button cap of a gamepad according to claim 2, wherein a bottom of the slot (210) is a penetrable structure, in each of the plurality of slot groups, a height of a side wall of each of the slots (210) adjacent to a center of the accommodating slot (21) is arranged to increase or decrease to form an abutment wall (211), and the abutment wall (211) is engaged in the gap formed between the hook body (120) and the connecting post (11), so that different accommodating depths are correspondingly formed in the slots (210).

5. The button cap of a gamepad according to claim 2, wherein a plurality of strip-shaped grooves (22) are arranged at intervals on a circumferential outer wall of the installation cover (2), the plurality of strip-shaped grooves (22) are respectively arranged to the plurality of slots (210), and a length of each of the plurality of strip-shaped grooves (22) indicates a height level of the button cap after each of the multiple hook (12) is inserted into the corresponding one of the plurality of slots (210), so as to facilitate user's identification and selection.

6. The button cap of a gamepad according to claim 2, further comprising a top cover (3) installed on the installation cover (2), wherein a side of the top cover (3) facing the installation cover (2) is provided with an inner accommodating slot (31) configured to be buckled on the installation cover (2), a middle part of the installation cover (2) is provided with an opening, and the side of the top cover (3) facing the installation cover (2) is provided with a protruding post (32) configured to be inserted into the opening.

7. The button cap of a gamepad according to claim 6, wherein a pattern is provided on a surface of the top cover (3) away from the installation cover (2) to increase a friction between the top cover (3) and user's fingers.

8. The button cap of a gamepad according to claim 1, wherein the gear structure has a connecting post (11) arranged on the base (1) and a plurality of tooth posts (14) arranged at intervals around the connecting post (11); a side of the installation cover (2) facing the base (1) is provided with an accommodating slot (21), a plurality of tooth slots (24) are arranged around a circumferential inner wall of the accommodating slot (21), the plurality of tooth slots (24) are sequentially divided into a plurality of tooth slot groups, and tooth heights of the plurality of tooth slot groups are arranged to increase or decrease, so that the plurality of tooth posts (14) are rotated to adjust the height of the button cap after the plurality of tooth posts (14) and the plurality of tooth slots (24) are correspondingly engaged to each other.

9. The button cap of a gamepad according to claim 8, wherein an outer edge (23) extending outwards from an outer circumference of an end of the installation cover (2) away from the accommodating slot (21) is provided to facilitate a user to toggle the installation cover (2).

10. The button cap of a gamepad according to claim 1, wherein a plurality of clamping arms (13) extending downwards are arranged at intervals on a circumference of a side of the base (1) away from the installation cover (2), and each of the plurality of clamping arms (13) is bent inwardly and elastic, so as to be detachably buckled on the joystick button of the gamepad.
